(19) United States
(12) Patent Application Publication
(10) Pub. No.: US 2005/0271848 A1
(43) Pub. Date: Dec. 8, 2005

(54) Adhesive clip assembly

(76) Inventors: Jonathan P. Kitchin, Leander, TX (US); Kenneth J. Hanley, Eagan, MN (US)

Correspondence Address: 3M INNOVATIVE PROPERTIES COMPANY, PO BOX 33427, ST. PAUL, MN, 55133-3427, US

(21) Appl. No.: 10/859,395

(22) Filed: Jun. 2, 2004

(51) Int. Cl. B32B 9/00

(52) U.S. Cl. 428/40.1

(57) ABSTRACT

An adhesive clip assembly adapted to be mounted on a support surface for supporting a display article includes a clip sheet having a front face and a back face and a layer of pressure sensitive adhesive disposed on at least a portion of the back face of the clip sheet. The clip sheet has a cut therethrough which defines a flexible tongue, and the tongue has a front side and a back side. That portion of the back face of the clip sheet which has adhesive disposed thereon includes the back side of the tongue. The front face of the clip sheet is free of adhesive. When the display article is disposed against the front face of the clip sheet and aligned at least partially under the tongue, the display article is retained in place relative to the clip sheet by adherence to the adhesive on the back side of the tongue and a spring force exerted by the flexible tongue toward the front face of the clip sheet.

### BACKGROUND OF THE INVENTION

The present invention relates to an adhesive clip assembly which uses pressure sensitive adhesive to support a display article on a substrate surface. More specifically, the adhesive clip assembly has an adhesive back face and an adhesive bearing tongue which engages a display article inserted between the tongue and a front face of the clip assembly.

A variety of small clips are used in homes and offices for attaching paper sheets to each other or to other surfaces for purposes of display or organization. The conventional bent wire paper clip, and other more recent variations made from stamped sheet metal or molded plastic, are widely used to attach several sheets of paper together, or to attach a small sheet such as a business card to the edge of a letter or folder. Paper clips of this type are limited in function to attachment at the periphery of a sheet. There are, however, occasions where it is preferable to attach a business card to the center portion of the letter (i.e., adjacent the signature) or to attach a business card to product samples that have no convenient edges to hold a wire paper clip.

The ubiquitous “refrigerator magnet” serves to support a sheet against a ferro-metallic surface. Clips are also available that combine a magnet with a spring grip portion. In addition, spring clips are available that have adhesive on one side used to adhere the clip to one surface, while the spring grip portion itself is used to secure a sheet of paper or other similar article in the clip. Magnetic or adhesive spring clips of this type are fairly bulky, due to the three dimensional design of the spring clip portion. Bulky spring clips are clearly unsuitable for attaching a small sheet to a letter (such as a business card to a letter) that is to be folded, and are generally too expensive to be considered for use as disposable items.

Clips are known that are formed from a unitary sheet of plastic or metal into which a notch, or flap or “tongue” has been cut. The tongue may be raised by bending it out of the plane of the rest of the sheet. A sheet of paper may be inserted under the tongue and held in place by the spring pressure of the tongue. The spring pressure of the tongue is determined by the bending modulus of the material forming the sheet. Adhesive versions of such clips have been made by positioning an adhesive on one side of the sheet in an area that is separate from the tongue portion of the clip. The function of the adhesive is to bond the clip to a target surface. The adhesive function (securing the clip to a target surface) is thus entirely separate from the function of the tongue (securing a paper sheet in the clip). In order to ensure that adequate spring pressure of the bent tongue is provided to hold a sheet of paper, it is necessary that such sheet material be fairly thick, and therefore relatively expensive.

### BRIEF SUMMARY OF THE INVENTION

The present invention provides a clip assembly adapted to be adhesively mounted on a support surface for supporting a sheet of paper or light weight item thereon. The clip assembly comprises a clip sheet having a front face and a back face. The clip sheet has a cut therethrough which defines a flexible tongue, with the tongue having a front side and a back side. A layer of pressure sensitive adhesive is disposed on at least a portion of the back face of the clip sheet, including the back side of the tongue, and the front face of the clip sheet is free of adhesive. A sheet of paper or light weight item disposed against the front face of the clip sheet and aligned at least partially under the tongue is retained in place relative to the clip sheet by adherence to the adhesive on the back side of the tongue and a spring force exerted by the flexible tongue toward the front face of the clip sheet.

In one embodiment, the present invention is a method of adhering a display member having an outer surface and an inner surface onto a support surface. The method comprises providing a clip sheet having a front face and a back face, wherein the clip sheet has a cut therethrough which defines a tongue and a tongue has the front side and a back side. A layer of pressure sensitive adhesive is disposed on at least a portion of the back face of the clip sheet, including the back side of the tongue. The front face of the clip sheet, including the front side of the tongue, is free of adhesive. The method further comprises inserting the display member between the tongue and the clip sheet, whereby at least a portion of the inner surface of the display member is disposed against the front face of the clip sheet and at least a portion of the outer surface of the display member is under the tongue and adhered thereto by the layer of pressure sensitive adhesive on the back side of the tongue so that the display member is fixed to the clip sheet to form an adhesive display assembly. The method further comprises urging the layer of pressure sensitive adhesive on the back face of the clip sheet against the support surface to adhere the adhesive display assembly to the support surface.

### BRIEF DESCRIPTION OF THE DRAWINGS

FIG. 1 is a front view of the first embodiment of an adhesive clip assembly of the present invention.

FIG. 2 is a front view of the adhesive clip assembly of FIG. 1, in which a display member has been inserted under a tongue of the adhesive clip assembly.

FIG. 3 is a sectional view as taken along lines 3-3 in FIG. 2.

FIG. 4 is a sectional view as taken along lines 4-4 in FIG. 2.

FIG. 5 is a sectional view as taken along lines 5-5 in FIG. 1.

FIG. 5A is a sectional view as taken along lines 5-5 in FIG. 1, showing an alternative embodiment for a free end of the tongue of the adhesive clip assembly.

FIG. 6 is a rear view of the adhesive clip assembly of FIG. 1.

FIG. 7 is a front view of an alternative embodiment of an adhesive clip assembly of the present invention.

FIG. 8 is a perspective view of the adhesive clip assembly of FIG. 7.

FIG. 9 is a front view of the adhesive clip assembly of FIG. 7, with a display member inserted under a tongue of the adhesive clip assembly.

FIGS. 10A-10K are front views of alternative embodiments of the adhesive clip assembly of the present invention.

FIG. 11 is a front view of a plurality of adhesive clip assemblies of the present invention supported on a backing layer for storage and dispensing thereof.

FIG. 12 is a perspective view of a roll of adhesive clip assemblies of the present invention, mounted on a rolled backing layer.

FIG. 13 illustrates a side view of a stack of adhesive clip assemblies of the present invention, arranged in a Z-fold configuration within an adhesive clip assembly dispenser.

FIG. 14 is a perspective exploded illustration illustrating the orientation of the adhesive clip assemblies in the stack of FIG. 13.

While the above-identified drawings set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art which fall within the scope and spirit of the principals of this invention. The figures may not be drawn to scale. Like reference numbers have been used throughout the figures to denote like parts.

### DETAILED DESCRIPTION

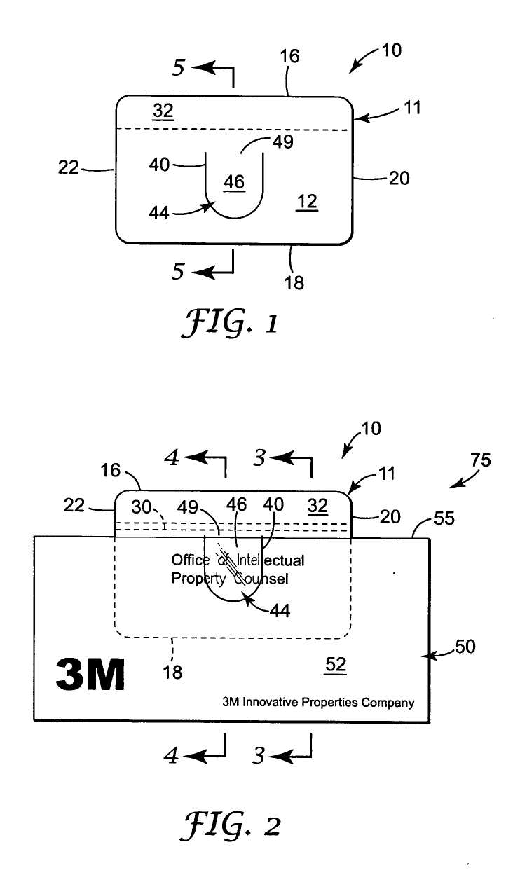

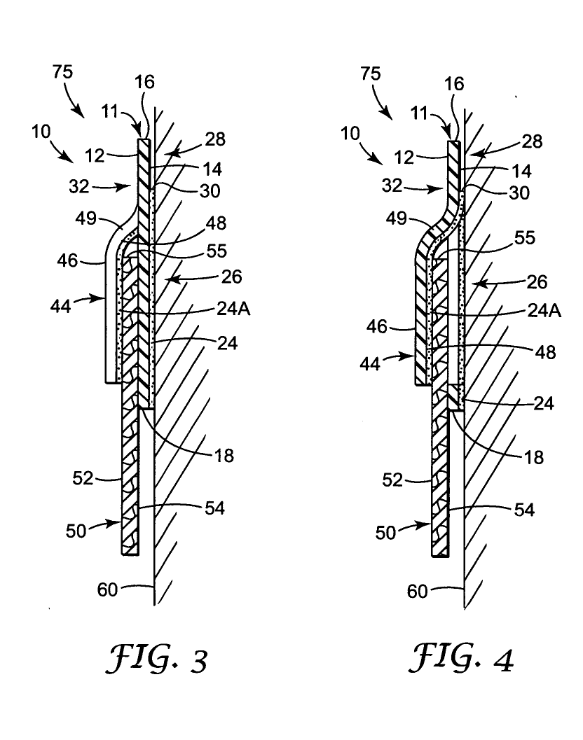

One embodiment of an adhesive clip assembly of the present invention is illustrated in FIGS. 1-6. In this embodiment, the adhesive clip assembly 10 is a rectangular sheet of material, such as the polymer sheet or paper clip sheet 11. The clip sheet 11 has a front face 12 (FIG. 1) and a back face 14 (FIG. 6). The clip sheet 11 has a top edge 16 and a bottom edge 18, and opposite right and left side edges 20 and 22, respectively. As seen in FIGS. 3, 4, 5 and 6, the back face 14 of the clip sheet 11 has a layer of pressure sensitive adhesive 24 thereon, while the front face 12 is free of adhesive.

In the embodiment illustrated in FIGS. 1-6, the back face 14 of the clip sheet 11 has a first area 26 bearing the pressure sensitive adhesive 24 and a second area 28 which is free of adhesive. In FIG. 6, the first area 26 is indicated by stipling, and can be seen to extend across the back face 14 from side edge 20 to side edge 22 and from bottom edge 18 to an upper adhesive edge 30 which defines the separation between areas 26 and 28. The free of adhesive second area 28 serves as a convenient means for handling the clip sheet 11.

When that portion of the clip sheet material is formed from a transparent material, the second area 28 on the back face 14 of the clip sheet 11 may include indicia thereon, such as a colored ink layer, which would then be visible to an observer of the front face 12 of the clip sheet 11. The indicia may be a single color or may include a printed message (e.g. “Grasp Here”). In addition, the indicia may be disposed on a top area 32 (FIG. 1) on the front face 12 of the clip sheet 11, corresponding generally in spatial arrangement to the second area 28.

The clip sheet 11 has a cut 40 therethrough which is shaped to define a flap or tongue 44. The tongue 44 is disposed within the first area 26 of the back face 14 of the clip sheet 11. The tongue 44 has a front side 46 and a back side 48, and remains connected to the clip sheet 11 at a tongue hinge area 49. The back side 48, as seen in FIG. 6, bears a portion of the layer of pressure sensitive adhesive thereon (as indicated in FIGS. 3, 4, 5 and 6 as adhesive 24A). The adhesive 24/24A maybe any suitable pressure sensitive adhesive, but in one embodiment, the adhesive is a repositionable pressure sensitive adhesive (and can be, for example, a microsphere adhesive). The term “repositionable” means the clip sheet adhesive can be adhered to and removed from a clean solid surface at least two times without substantially losing tack. In one embodiment, the clip sheet can be adhered to and removed from a clean solid surface at least ten times without losing tack. In another embodiment, the clip sheet can be adhered to and removed from a clean solid surface at least twenty times without losing tack.

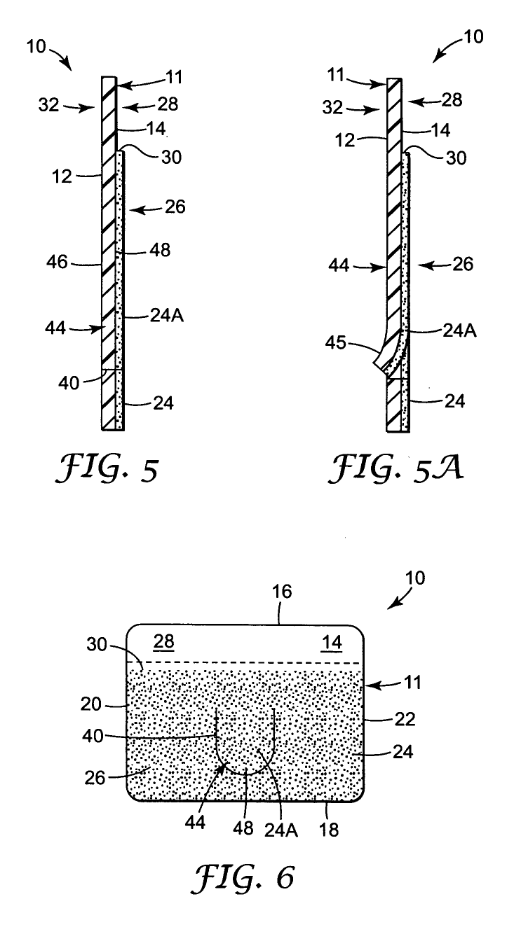

As seen in FIG. 5, the clip sheet 11 and tongue 44 formed therefrom lie in the same plane. The clip sheet can be formed from any suitable planar material, such as a polymer, paper or metal sheet material, and may be partially or totally transparent or opaque. If a polymer sheet material is used, the polymer sheet material may be selected from the group consisting of polyester and polypropylene.

FIGS. 2, 3 and 4 illustrate the adhesive clip assembly 10 in use. A display article 50 (such as a business card, sheet of paper, photograph or the like) has an outer surface 52 and an inner surface 54. The display article 50 has its inner surface 54 disposed against a front face 12 of the clip sheet 11, and is aligned at least partially under the tongue 44. Accordingly, a portion of the outer surface 52 of the display article 50 is engaged by the adhesive 24A on the back side 48 of the tongue 44 and adhered thereto. In one embodiment, the clip sheet 11 (and thus the tongue 44 integrally formed therefrom) is formed of a flexible material. The insertion of the display article 50 between the front face 12 of the clip sheet 11 and the tongue 44 thus flexes the tongue 44 outwardly (as seen in FIGS. 3 and 4) away from any clip sheet 11. The flexible material is resilient and the tongue 44 is thus naturally spring biased back to its at-rest position (coplanar with the clip sheet 11, as seen in FIG. 5). The tongue 44 exerts a spring force on the display article 50, urging it against the front face 12 of the clip sheet 11. The display article 50 is thus retained in place relative to the adhesive clip assembly 10 by this spring force and also by the adhesive 24A on the back side 48 of the tongue 44. While either force may be sufficient to hold the display article 50 (depending upon its weight and configuration), the two forces together combine to define an extremely versatile and unique adhesive clip assembly. By inserting an upper edge 55 of the display article 50 as far under the tongue 44 as possible (up to the hinge area 49), a fixed and maximum amount of adhesive 24A on the back side 48 of the tongue 44 can be brought to bear on each display article retained by a particular adhesive clip assembly 10. Once the display article 50 is mounted to the adhesive clip assembly 10, they collectively define an adhesive display assembly 75 (see FIG. 2).

In FIG. 2, it can be seen that the display member 50 has indicia thereon. In one embodiment, a clip sheet 11 (or at least its tongue 44) is formed from a material that is sufficiently transparent when adhered to the display article 50 that indicia on the outer surface 52 of the display article 50 is visible through the tongue 44.

As illustrated by the FIG. 6, a majority of the back face 14 of the clip sheet 11 is covered with adhesive 24. The adhesive 24 on the back face 14 of the adhesive clip 11 is used to adhere the adhesive clip assembly 10 to a substrate surface 60, as seen in FIGS. 3 and 4. In one embodiment, an area of the back side of 48 of the tongue 44 bearing adhesive 24A is less than half of the first area 26 on the back face 14 of the clip sheet 11. The cut 40 which defines the tongue 44 is spaced from peripheral edges of the clip sheet 11 (such as edges 18, 20 and 22), thereby defining an adhesive bearing border portion of the clip sheet 11 extending about the tongue 44. In one embodiment, the border portion of the clip sheet 11 is formed from a material that is sufficiently transparent when adhered to the display article 50 that indicia on the outer surface 52 of the display article 50 is visible through the border portion.

As seen in FIG. 5A, in an alternative embodiment of the adhesive clip assembly 10, the tongue 44 has a free end 45 which is raised relative to the front face 12 of the clip sheet 11, to more readily facilitate insertion of a display article such as a sheet of paper or photo between the tongue 44 and front face 12 of the clip sheet 11. For the clip sheet 11 illustrated in FIG. 5, a similar effect of creating separation between a free end of the tongue and the front face 12 of the clip sheet 11 can be achieved by flexing the clip sheet 11 (e.g., bowing the center of the clip sheet 11 to the left as seen in FIG. 5).

In use, the clip sheet 11 is mounted to a substrate surface 60 by means of the adhesive 24 on the back face 14 thereof, and then the display article 50 may be inserted under the tongue 44 as described above. More commonly, however, the display article 50 will first be inserted under the tongue 44 of the clip sheet 11 and adhered thereto to form the adhesive display assembly 75 comprising both the adhesive clip assembly 10 and display article 50. The adhesive display assembly 75 is then adhered to a substrate surface 60. Handling of the adhesive display assembly 75 is facilitated by grasping an upper portion of the adhesive clip assembly 10 which has no adhesive on its front face 12 (area 32) or back face 14 (area 28). As mentioned above, the upper portion may also include indicia. In one embodiment, a lower portion of the clip sheet 11 (including even the tongue 44) may also include indicia thereon, which may or may not complement or highlight any indicia borne on the outer surface 52 of the display article 50. When the adhesive is repositionable pressure sensitive adhesive, the adhesive display assembly 75 may be removed from the substrate surface 60 and repositioned thereon (or on another surface), or the display article 50 may be removed and another display article adhered in its place on the adhesive clip assembly 10.

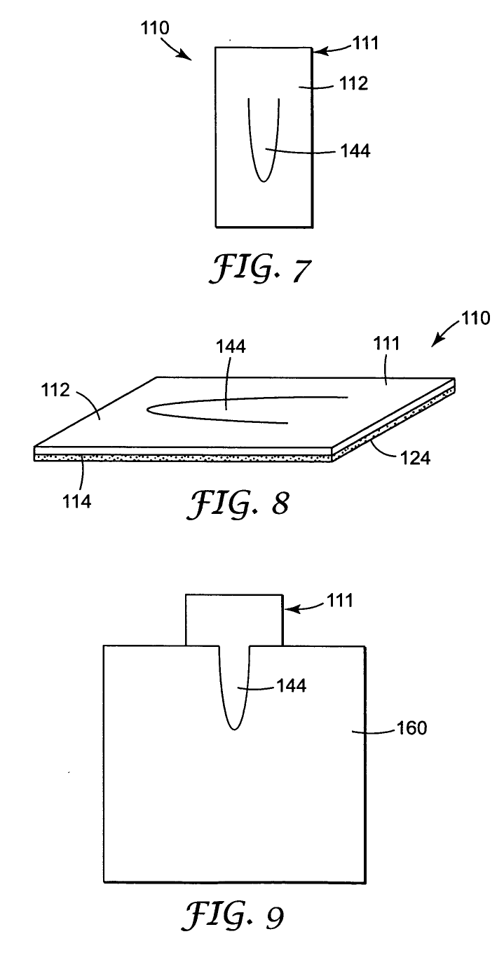

FIGS. 7-9 illustrate an alternative embodiment of the adhesive clip assembly of the present invention. In this embodiment, an adhesive clip assembly 110 has a clip sheet 111 with a tongue 144 formed therein, but the tongue 144 is more elongated and narrower than the tongue 44 of the clip sheet 11. The clip sheet 111 has a front face 112 and a back face 114, but as seen in FIG. 8, the back face 114 of the clip sheet 111 is entirely covered by a layer of adhesive 124 (including a back side of the tongue 144). FIG. 9 illustrates a display article 160 inserted under the tongue 144 and adhered thereto by adhesive on the back side of the tongue 144 and the spring force of the tongue 144.

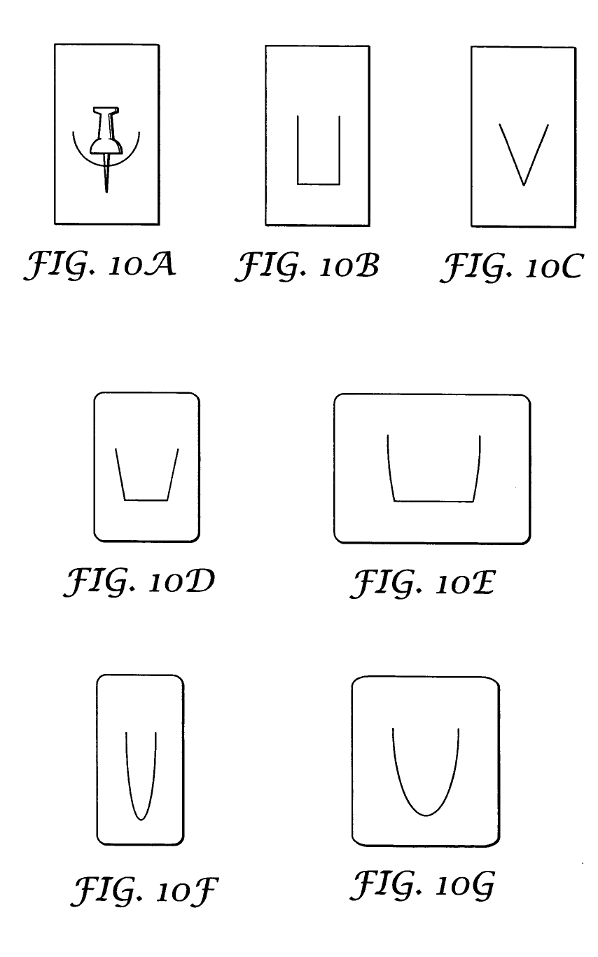

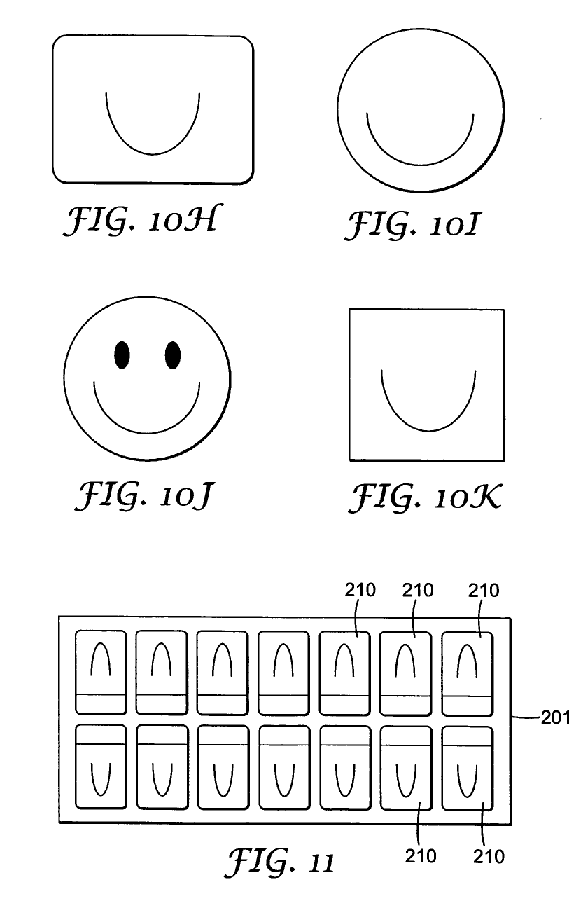

FIGS. 10A-10J illustrate alternative embodiments of the adhesive clip assembly of the present invention. As can be seen, the periphery of the adhesive clip assembly can assume any desired shape, and the tongue formed thereon may be of any suitable shape to allow its free end to be raised to permit insertion of a display article beneath the tongue. Representative tongue shapes comprise different configurations, such as rectangular, triangular, semicircular, elliptical or a combination or permutation of such shapes. The adhesive clip assembly can vary in size, and in stiffness of the sheet material it is formed from, depending upon the intended application. A smaller adhesive clip assembly may be used to attach flat objects such as a business card to a report cover, binder or letter. Larger, stiffer adhesive clip assemblies may be used to attach notices or other objects to walls or vertical surfaces, taking the place of the more expensive and bulky clips that are known (e.g., metallic spring clips or adhesive mounted plastic molded clips). Indicia may be provided on the adhesive clip assembly, such as a colored band along a top edge thereof or other indicia such as illustrated in FIG. 10A (an image of a push pin) or FIG. 10J (an image of a face). The indicia on the adhesive clip assembly may correspond to indicia on the intended display article, such as the repetition of a name and phone number on the adhesive clip assembly of such information on a business card display article.

The adhesive clip assembly of the present invention thus provides a low profile and inexpensive (i.e., disposable) means for permanently or temporarily attaching display articles to substrate surfaces. When a repositionable pressure sensitive adhesive is used on the back of the adhesive clip assembly, it can then be reused for displaying alternative display articles or repositioned as desired.

For storage prior to use, adhesive clip assemblies of the present invention may be releasably secured to a backing sheet. FIG. 11 illustrates a backing sheet 201 bearing a plurality of adhesive clip assemblies 210. The adhesive clip assemblies 210 are adhered to the backing sheet 201 by the adhesive on the back of each adhesive clip assembly. The backing sheet 201 may or may not have a release coating thereon, and may be formed from any suitable material such as paper or plastic.

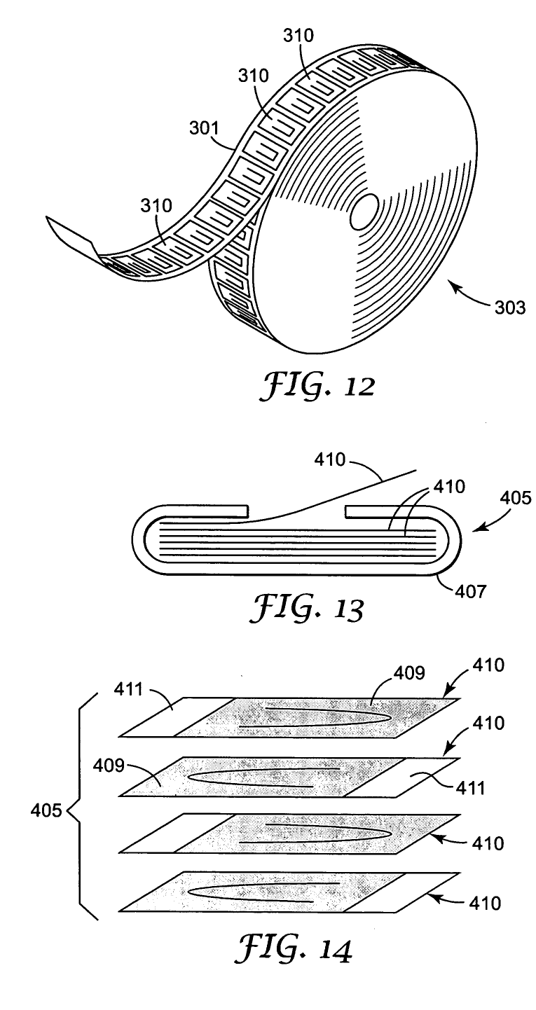

Alternatively, a plurality of adhesive clip assemblies may be provided in roll form. In one embodiment, a backing sheet 301 is rolled into a roll 303, as seen in FIG. 12. The backing sheet 301, on one side thereof, bears a plurality of adhesive clip assemblies 310, by means of the adhesive on the backs thereof. The backing sheet 301 may or may not have a release coating thereon, and may be formed from any suitable material such as paper or plastic. In another embodiment, a linerless roll of adhesive clip assemblies may be provided, where the front of each adhesive clip assembly is treated with a low adhesion backsize coating to facilitate separation of the adhesive on the back of other adhesive clip assemblies, and the adhesive clip assemblies are separable (either by cutting each adhesive clip assembly from the roll or by preformed perforations permitting separation).

Another dispensing alternative is to arrange the adhesive clip assemblies in stacked form. FIGS. 13 and 14 illustrate a pad 405 of adhesive clip assemblies 410. The adhesive clip assemblies in the pad 405 are arranged in a Z-fold pad configuration, where each adjacent adhesive clip assembly 410 of the pad 405 alternates in orientation by 180 degrees. One end portion of each adhesive clip assembly 410 is adhesive free (on both sides thereof). The pad 405 is retained within a suitable dispensing apparatus such as a flexible dispenser 407 to allow a single adhesive clip assembly 410 to be peeled away from the pad 405 while exposing one end of the next adhesive clip assembly 410 in the stack. A dispensing mechanism of this type, generally known as a “pop-up dispenser”, and sheets dispensed therefrom, are described in U.S. Pat. No. 5,769,270, which is incorporated by reference herein. Alternative sheets and pop-up dispensers are described in U.S. Pat. Nos. 4,770,320 and 4,907,825, both of which are incorporated by reference herein. FIG. 14 illustrates, in exploded view, a plurality of the adhesive clip assemblies 410 in such a stack or pad 405. A first end portion 409 of the adhesive clip assembly 410 bears pressure sensitive adhesive on its back face, while a second portion 411 bears no adhesive (on either face). For each adhesive clip assembly 410, the tongue is formed in the adhesive first end portion 409, with its hinged end facing the adhesive-free second end portion 410.

In one specific example, an adhesive clip assembly having the general configuration illustrated in FIG. 10K was formed from a transparent 5 mil. polyester film. Microsphere adhesive was applied to a back face of the film using 3M 9415 doublesided repositionable adhesive tape. The adhesive covered the majority of the back face, including the back side of a tongue which was cut into the film. A top portion of the adhesive clip assembly bore a color layer on the back face thereof(on an area where there was no adhesive) and the front face thereof was free of adhesive. An 8½×11 sheet of paper was inserted under the tongue, and the tongue was pressed lightly down to attach the adhesive-coated back side of the tongue to the sheet of paper. The resultant adhesive display assembly (adhesive clip assembly and sheet of paper) was then applied to a vertical painted wall to hold and display the sheet of paper thereon.

Although the present invention has been described with reference to preferred embodiments, workers skilled in the art will recognize that changes may be made in form and detail without departing from the spirit and scope of the invention.

1. An adhesive clip assembly adapted to be mounted on a support surface for supporting a sheet of paper or light weight item, the adhesive clip assembly comprising:
a clip sheet having a front face and a back face, the clip sheet having a cut therethrough which defines a flexible tongue, and the tongue having a front side and a back side; and
a layer of pressure sensitive adhesive disposed on at least a portion of the back face of the clip sheet, including the back side of the tongue, and the front face of the clip sheet being free of adhesive, whereby a sheet of paper or light weight item disposed against the front face of the clip sheet and aligned at least partially under the tongue is retained in place relative to the clip sheet by adherence to the adhesive on the back side of the tongue and a spring force exerted by the flexible tongue toward the front face of the clip sheet.

2. The adhesive clip assembly of claim 1 wherein the adhesive is a repositionable pressure sensitive adhesive.

3. The adhesive clip assembly of claim 1 wherein the tongue and clip sheet lie in the same plane when no sheet or light weight item is disposed therebetween.

4. The adhesive clip assembly of claim 1 wherein the clip sheet has an outer periphery and the cut is spaced therefrom, thereby defining a border portion of the clip sheet extending about the tongue.

5. The adhesive clip assembly of claim 1 wherein the tongue has a free end which is raised relative to the front face of the clip sheet to facilitate insertion of a sheet of paper or light weight item under the tongue.

6. The adhesive clip assembly of claim 1 wherein the clip sheet is selected from the group consisting of polymer, paper and metal sheet material.

7. The adhesive clip assembly of claim 6 wherein the clip sheet is a polymer sheet material selected from the group consisting of polyester and polypropylene.

8. The adhesive clip assembly of claim 7 wherein the clip sheet has a thickness equal to or less than about 0.005 inches.

9. The adhesive clip assembly of claim 1 wherein the back face of the clip sheet has a first area bearing the layer of pressure sensitive adhesive and a second area which is free of adhesive.

10. The adhesive clip assembly of claim 9 wherein the tongue is formed within the first area.

11. The adhesive clip assembly of claim 10 wherein the tongue has a free end and a hinged end, and wherein the hinged end of the tongue faces the second area.

12. The adhesive clip assembly of claim 10 wherein an area of the back side of the tongue is less than half of the first area on the back face of the clip sheet, less the area of the tongue.

13. The adhesive clip assembly of claim 9, and further comprising:
indicia disposed on the clip sheet in the manner which is visible to an observer of the first face thereof, wherein the indicia is disposed adjacent that portion of the clip sheet corresponding to the second area on the back face of the clip sheet.

14. The adhesive clip assembly of claim 13 wherein the clip sheet is a transparent substrate and the indicia is disposed on the back face thereof.

15. The adhesive clip assembly of claim 13 wherein the clip sheet is an opaque substrate and the indicia is disposed on the front face thereof.

16. The adhesive clip assembly of claim 9 wherein the pressure sensitive adhesive is disposed to cover a majority of the back face of the clip sheet.

17. The adhesive clip assembly of claim 1 wherein the tongue is sufficiently transparent when adhered to the sheet of paper or light weight item so that indicia on the sheet of paper or light weight item is visible through the tongue.

18. The adhesive clip assembly of claim 1, and further comprising:
a backing layer having an adhesive release surface on a top side thereof,
wherein a plurality of the clip sheets are adhered to the top side of the backing layer for dispensing therefrom, via the pressure sensitive adhesive on the back face of each clip sheet.

19. The adhesive clip assembly of claim 1 wherein the backing layer is a sheet.

20. The adhesive clip assembly of claim 1 wherein the backing layer is a rolled web.

21. The adhesive clip assembly of claim 1 wherein, prior to dispensing and use thereof, a plurality of clip sheets arc in stacked form, adhered together via the pressure sensitive adhesive on the back face of each clip sheet.

22. The adhesive clip assembly of claim 21 wherein the plurality of clip sheets are stacked in a Z-fold configuration.

23. The adhesive clip assembly of claim 21, and further comprising:
a dispenser for retaining the plurality of clip sheets in stacked form.

24. The adhesive clip assembly of claim 1, and further comprising:
indicia disposed on the clip sheet in a manner which is visible to an observer of the first face thereof.

25. A method of adhering a display article having an outer surface and an inner surface onto a support surface comprises:
providing a clip sheet having a front face and a back face, the clip sheet having a cut therethrough which defines a tongue, the tongue having a front side and a back side, a layer of pressure sensitive adhesive disposed on at least a portion of the back face of the clip sheet, including the back side of the tongue, and the front face of the clip sheet, including the front side of the tongue, being free of adhesive;
inserting the display article between the tongue and the clip sheet, whereby at least a portion of the inner surface of the display article is disposed against the front face of the clip sheet and at least a portion of the outer surface of the display article is under the tongue and adhered thereto by the layer of pressure sensitive adhesive on the back side of the tongue so that the display article is fixed to the clip sheet to form an adhesive display assembly; and
urging the layer of pressure sensitive adhesive on the back face of the clip sheet against the support surface to adhere the adhesive display assembly to the support surface.

26. The method of claim 25 wherein the tongue is resiliently flexible, and the display member is further fixed to the clip sheet by a spring force exerted by the flexible tongue toward the front face of the clip sheet.

27. The method of claim 25 wherein the tongue is sufficiently transparent so that indicia on the outer surface of the display member is visible through the tongue.

28. The method of claim 25 wherein the back face of the clip sheet has an area which is free of adhesive, to facilitate handling of the clip sheet alone and to facilitate handling the adhesive display assembly.

29. The method of claim 28 wherein the tongue has a free end and a hinged end, and wherein the hinged end faces the area on the back face of the clip sheet which is free of adhesive.

30. The method of claim 25 wherein the layer of adhesive is a repositionable pressure sensitive adhesive.

31. The adhesive clip assembly of claim 1 and further comprising:
indicia disposed on the tongue, the indicia being visible to an observer of the first face of the clip sheet.

32. The method of claim 25, and further comprising:
providing indicia disposed on the tongue, the indicia being visible to an observer of the first face of the clip sheet.
